(19) United States
(12) Patent Application Publication
(10) Pub. No.: US 2011/0018251 A1
(43) Pub. Date: Jan. 27, 2011

(54) Self-Adhesive Notepaper Set

(76) Inventor: David C.T. JOUR, Taipei (TW)

Correspondence Address: TROXELL LAW OFFICE PLLC, SUITE 14044, 5205 LEESBURG PIKE, FALLS CHURCH, VA, 22041, US

(21) Appl. No.: 12/509,448

(22) Filed: Jul. 25, 2009

(51) Int. Cl. B42D 17/00

(52) U.S. Cl. 281/44

(57) ABSTRACT

A self-adhesive notepaper set, which comprising: several film units, composed of multiple apparent self-adhesive fluorescent films superimposed in a staggered form; the apparent self-adhesive fluorescent film is of various fluorescent colors, such as: red, orange, yellow, green and blue; a seating, which is a hollow space formed by the base plate and external housing; at the interior of the external housing, several rows of spacers are arranged at interval for embedding of the aforementioned film units, and a notch spanning all spacers is set for extracting the uppermost free end of the film unit; a baffle plate is arranged at both ends within the external housing; with this design, the transparent self-adhesive fluorescent film of vivid colors can be extracted easily in lieu of the marking lines of the fluorescent marker, thus saving the integrity of documents.

### BACKGROUND OF INVENTION

1. Field of the Invention

The present invention relates generally to a self-adhesive notepaper set, and more particularly to an innovative one which can be easily carried, held and applied with the use of apparent self-adhesive fluorescent film, thereby improving the visual effect in a broad range of applications.

2. Description of Related Art

Self-adhesive notepaper is one of most commonly used products in recent years. It is characterized by that, a back gum made of special material is applied to one side of the blank paper. When it is intended to tear down the object, no residue of the adhesive back gum is retained on the surface, so the people could send messages conveniently to the interested parties via the self-adhesive notepaper and enable them to handle the matters immediately after coming back. With the advancement of education and improvement of knowledge, self-adhesive notepapers are widely applied to record the real-time important matters as an indispensable everyday article.

A typical notepaper set is structurally designed in such a manner that multiple notepapers are superimposed and placed into a seating, so upper layers of notepaper can be ripped off from the preset opening of the seating; a proper amount of adhesives are applied into the spacing between two notepapers equidirectionally for adhesion and positioning; owing to the extremely thin structure of the self-adhesive notepaper, the entire notepaper may be disengaged from the seating when the user intends to tear down only a piece of paper.

Secondly, the seating of the notepaper with a certain volume and weight makes it only suitable for being arranged on the table, not for being carried by the user.

Furthermore, the notepaper structure makes it difficult to win profit and improve its competitiveness due to insufficient innovation for the structure and appearance.

Additionally, the notepaper can be used for noting important information, and this can be realized by the users with introduction of fluorescent markers of different colors. However, some important documents with specific purposes or materials place many restrictions on the fluorescent marker, in particular, users may find it difficult to read the documents if many marking lines and colors are noted on the same document.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### SUMMARY OF THE INVENTION

The main objective of the present invention is to provide an easy-to-use and easy-to-tear self-adhesive notepaper set with improved convenience and diversified efficacies.

The second objective of the present invention is to provide a self-adhesive notepaper set, which is fitted with an internal housing and external housing, allowing to tear down easily the self-adhesive transparent fluorescent film. In particular, at one side of the housing there is a hanging board with a single round hole, and at the other side there is a long hanging board with round hole and oblong hole, so the housing can be mated securely with universal manual or loose-leaf notebook, realizing better ease-of-use and applicability.

The third objective of the present invention is to provide an aesthetically-pleasing notepaper set wherein a transparent fluorescent film can be used in lieu of the fluorescent marker to improve the visual effect.

The self-adhesive notepaper set of the present invention structurally comprises: multiple film units, which are superimposed by multiple layers of apparent self-adhesive fluorescent films; the apparent self-adhesive fluorescent film is of various fluorescent colors, such as: red, orange, yellow, green and blue; a seating, which is a hollow space formed by the base plate and external housing; moreover, at the interior of the external housing, several rows of spacers are arranged at interval for embedding of the aforementioned film units, and a notch spanning all spacers is set for extracting the uppermost piece of film from the film unit; and, baffle plates are arranged at both ends within the external housing; with this combination, all film units can be embedded into the spacing of two spacers within the seating; then, the free end of the uppermost apparent self-adhesive fluorescent film of every film unit is protruded out of the external housing from the notch, enabling the users to select and extract them easily; furthermore, all film units can be rearranged in an orderly manner.

A hanging board along with a hanging hole is connected to any edge of the seating body, so the seating can be freely hung for easy access with improved applicability.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1: an exploded view of the self-adhesive notepaper set of a preferred embodiment of the present invention.

FIG. 2: a top sectional view of the self-adhesive notepaper set of a preferred embodiment of the present invention.

FIG. 3: an outside view of the self-adhesive notepaper set of a preferred embodiment of the present invention.

FIG. 4: an application view of the self-adhesive notepaper set of a preferred embodiment of the present invention.

FIG. 5: an extracting view of the self-adhesive notepaper set of a preferred embodiment of the present invention.

FIG. 6: an outside view of the self-adhesive notepaper set of another preferred embodiment of the present invention.

### DETAILED DESCRIPTION OF THE INVENTION

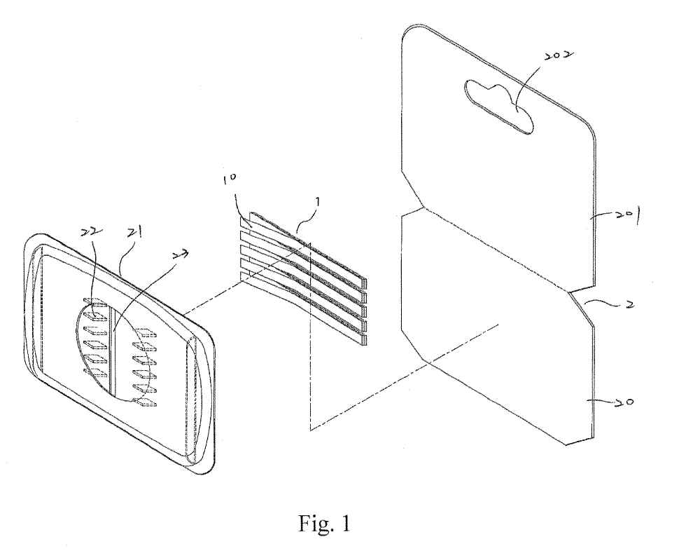

Referring to FIG. 1, a “self-adhesive notepaper set” of the present invention comprising:

several film units 1, each of which contains multiple apparent self-adhesive fluorescent films 10 superimposed in a staggered form; the apparent self-adhesive fluorescent film 10 is of various fluorescent colors, such as: red, orange, yellow, green and blue, which can be attached onto the letters for replacing the marking lines of the fluorescent marker, thus realizing diversified applications and functions;

a seating 2, which is a hollow space formed by the base plate 20 and external housing 21; a hanging board 201 along with a hanging hole 202 is connected to any edge of the plate body 20, so the seating 2 can be freely hung; the external housing 21 is made of transparent or semi-transparent materials, and decorated by arced edge; at the interior of the external housing 21, several rows of spacers 22 are arranged at interval for embedding of the aforementioned film units 1, and a notch 23 spanning all spacers 22 is set for extracting the uppermost free end of the film unit 1; besides, a baffle plate 24 is arranged at both ends within the external housing 21, so all film units 1 can be rearranged in an orderly manner by simply joggling them.

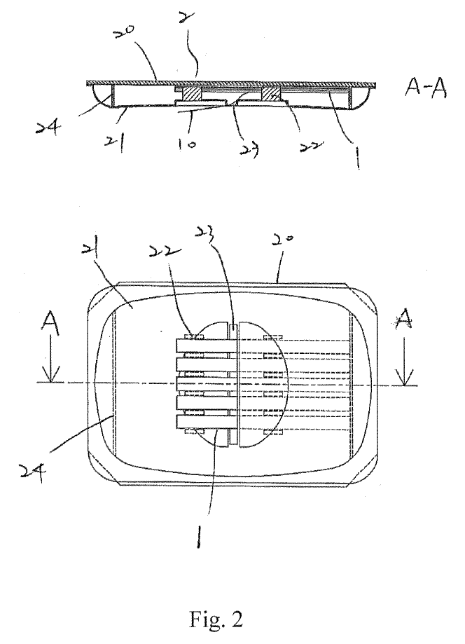

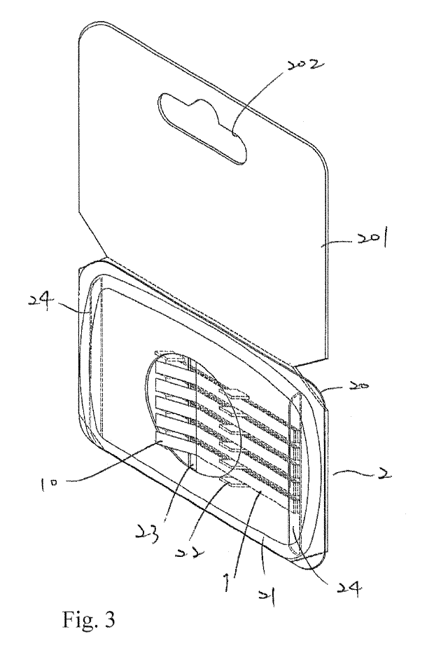

Referring to FIG. 2, when said film unit 1 is combined with the seating 2, two or more film units 1 of different colors are separately placed into the spacing between two adjacent spacers 22; as the external housing 21 is decorated by arced edge, the film units 1 are arranged in curved form if viewing from the top, presenting a colorful visual effect along with the bright fluorescent colors; next, the free end of the uppermost apparent self-adhesive fluorescent film 10 of every film unit 1 is protruded out of the external housing 21 from its notch 23, enabling the users to select and extract them easily; hence, a complete and innovative self-adhesive notepaper set is assembled as shown in FIG. 3.

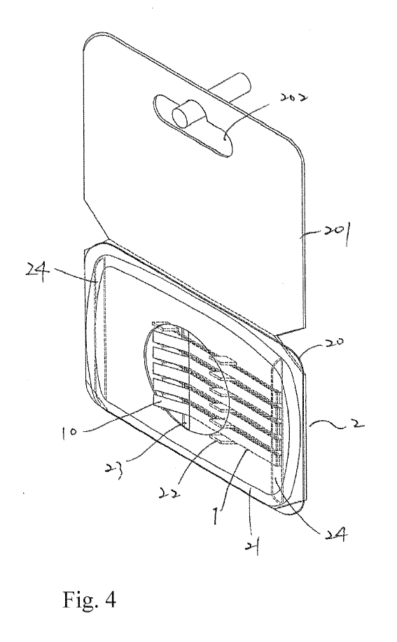

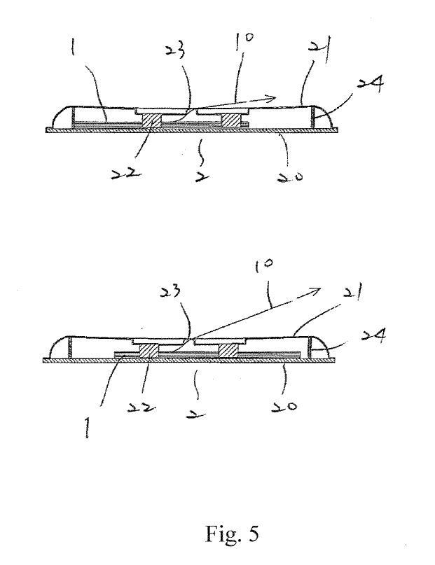

When the aforementioned self-adhesive notepaper set is put into operation, the users may lay it flat or hang it depending on their own habit; referring to FIG. 4, the notepaper set is arranged in a readily accessible state; thus, the users may select freely any film unit 1 depending on the intended fluorescent colors and demands; when it is intended to tear down and extract the uppermost apparent self-adhesive fluorescent film 10, the remaining portion of the same group of film units 1 may slide between the spacers 22; referring to FIG. 5, the transparent external housing allow to extract in an open way due to a variety of bright fluorescent colors; next, the apparent self-adhesive fluorescent film 10 of bright fluorescent color is directly attached to the intended letters in lieu of the marking lines of fluorescent marker; this can guarantee the integrity of original documents while preventing scrabbling on the surface; in such case, it is only required to tear down simply and easily the apparent self-adhesive fluorescent film 10; and all film units 1 can be rearranged in an orderly manner via the help of baffle plate 24 by simply joggling them.

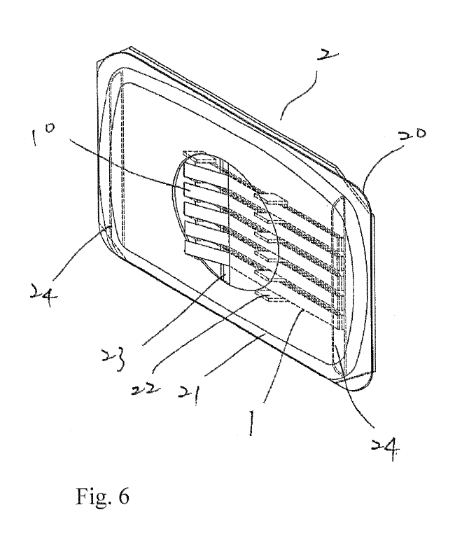

Referring to FIG. 6, a hanging board 201 is arranged at any edge of the plate body 20 of the seating 2 for hanging purpose; other than a prefabricated plate body 20, an independent plate body 20 without hanging board 201 can be provided for space-saving purpose with improved accessibility and applicability.

Although the invention has been explained in relation to its preferred embodiment, it is to be understood that many other possible modifications and variations can be made without departing from the spirit and scope of the invention as hereinafter claimed.

1. A self-adhesive notepaper set, comprising:
several film units, each of which contains multiple apparent self-adhesive fluorescent films superimposed in a staggered form; and
a seating, which is a hollow space formed by the base plate and external housing; at the interior of the external housing, several rows of spacers are arranged at interval for embedding of the aforementioned film units, and a notch spanning all spacers is set for extracting the uppermost free end of the film unit.

2. The self-adhesive notepaper set as claimed in claim 1, wherein a hanging board is arranged at one side of the seating.

3. The self-adhesive notepaper set as claimed in claim 1, wherein the external housing is made of transparent or semi-transparent materials.

4. The self-adhesive notepaper set as claimed in claim 1, wherein two or more film units are of different fluorescent colors.

5. The self-adhesive notepaper set as claimed in claim 1, wherein a baffle plate is arranged separately at both ends within the external housing.
